(19) United States
(12) Patent Application Publication
(10) Pub. No.: US 2008/0280053 A1
(43) Pub. Date: Nov. 13, 2008

(54) Reactive Dyes Containing Divalent Sulfur in Non-Reactive Side Chain at Trizine Nucleus

(75) Inventors: Anthony Lawrence, Koln (DE); Werner Hubert Russ, Florsheim-Wicker (DE); Warren J. Ebenezer, Greater Manchester (GB)

Correspondence Address: CONNOLLY BOVE LODGE & HUTZ, LLP, P O BOX 2207, WILMINGTON, DE, 19899, US

(73) Assignee: DYSTAR TEXTILFARBEN GMBH & CO. DEUTSCHLAND KG, Frankfurt am Main (DE)

(21) Appl. No.: 11/719,756

(22) PCT Filed: Nov. 15, 2005
(86) PCT No.: PCT/EP05/55991

§ 371 Date: Jun. 26, 2007

(30) Foreign Application Priority Data
Nov. 19, 2004 (GB) 0425551.9

(51) Int. Cl. B05D 1/02; C09B 29/00

(52) U.S. Cl. 427/421.1; 534/803; 534/797

(57) ABSTRACT

The present invention refers to dyestuffs of the formula (I) wherein R¹, R² are independently H, optionally substituted alkyl or optionally substituted aryl, R³ is optionally substituted alkyl or optionally substituted aryl, an organic acyl group (i.e. acetyl, propionyl, benzoyl etc.) or an organic thioacyl group (i.e. 10 thioacetyl, thiopropionyl, thiobenzoyl etc.), all of which may or may not bear a reactive group able to form a dye-fibre bond, R⁴ is any coloured organic group, which may or may not bear a reactive group able to form a dye-fibre bond, L is any carbon containing linking group that is aliphatic, aromatic, or a combined alkyl-aryl group such as benzyl or phenethyl, X is halogen or tertiary ammonium or an optionally substitute aryl amine, processes for the preparation of said dyestuffs and their use for dyeing and printing hydroxy- and/or carboxamido-containing fiber materials.

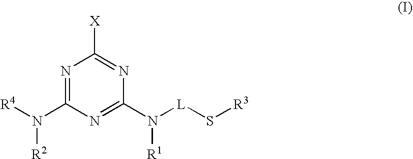

The present invention relates to the field of fibre-reactive dyes.

Good chlorine fastness is an increasingly important criterion for reactive dyes.

The inventors of the present invention have surprisingly found that dyestuffs according to the general formula (I) containing a divalent sulfur atom exhibit unexpected and unpredictable high fastness to chlorinated water Surprisingly in certain cases dyestuffs according to the general formula (I) also exhibit an improved fastness toward oxidative wash-down. These fastnesses have proven to be significantly higher than comparable structures not containing a divalent sulfur atom.

The present invention claims dyestuffs of the general formula (I)

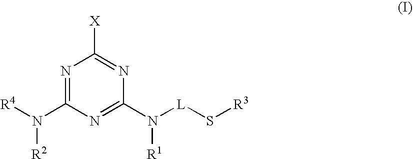

wherein
R¹, R² are independently H, optionally substituted alkyl or optionally substituted aryl,
R³ is optionally substituted alkyl or optionally substituted aryl, an organic acyl group (i.e. acetyl, propionyl, benzoyl etc.) or an organic thioacyl group (i.e. thioacetyl, thiopropionyl, thiobenzoyl etc.), all of which may or may not bear a reactive group able to form a dye-fibre bond,
R⁴ is any coloured organic group, which may or may not bear a reactive group able to form a dye-fibre bond,
L is any carbon containing linking group that is aliphatic, aromatic, or a combined alkyl-aryl group such as benzyl or phenethyl,
X is halogen or tertiary ammonium or an optionally substituted aryl amine.

R¹, R² and R³ alkyl may be straight-chain or branched and is for example methyl, ethyl, n-propyl, i-propyl or n-butyl. Preferably, R¹ and R² are hydrogen or methyl. R³ is preferably C₁-C₄ alkyl, hydroxyethyl or hydroxypropyl, sulfatoethyl, phosphatoethyl, sulfatopropyl or phosphatopropyl; R³ is especially preferred hydroxyethyl.

R⁴ is a sulphonated chromophoric system, typical of those used for reactive dyes for cotton such as the radical of a mono- or diazo dye; the radical of an anthraquinone or a triphendioxazine dye, especially preferred azo based chromophoric systems.

X is preferably chlorine; fluorine, quaternary ammonium, such as an optionally substituted pyridinium salt or an optionally substituted aryl amine bearing a reactive group capable of forming a dye-fibre bond, such as a sulfatoethylsulfone, 2-haloethylsulfone or 1,2-dihaloethylsulfone.

The dyestuffs of the present invention can be present as a preparation in solid or liquid (dissolved) form. The dyestuff preparation may contain one or more dyestuffs of the present invention. In solid form they generally contain the electrolyte salts customary in the case of water-soluble and in particular fibre-reactive dyes, such as sodium chloride, potassium chloride and sodium sulfate, and also the auxiliaries customary in commercial dyes, such as buffer substances capable of establishing a pH in aqueous solution between 3 and 7, such as sodium acetate, sodium borate, sodium bicarbonate, sodium citrate, sodium dihydrogen-phosphate and disodium hydrogenphosphate, small amounts of siccatives or, if they are present in liquid, aqueous solution (including the presence of thickeners of the type customary in print pastes), substances which ensure the permanence of these preparations, for example mold preventatives.

In general, the dyestuffs of the present invention are present as dye powders containing 10 to 80% by weight, based on the dye powder or preparation, of a strength-standardizing colorless diluent electrolyte salt, such as those mentioned above. These dye powders may additionally include the aforementioned buffer substances in a total amount of up to 10%, based on the dye powder. If the dyestuffs and dyestuff mixtures of the present invention are present in aqueous solution, the total dye content of these aqueous solutions is up to about 50% by weight, for example between 5 and 50% by weight, and the electrolyte salt content of these aqueous solutions will preferably be below 10% by weight, based on the aqueous solutions. The aqueous solutions (liquid preparations) may include the aforementioned buffer substances in an amount which is generally up to 10% by weight, for example 0.1 to 10% by weight, preference being given to up to 4% by weight, especially 2 to 4% by weight.

A dyestuff of the formula (I) may for example be prepared by reacting a dyestuff of the formula (II)

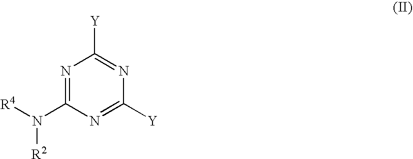

wherein
R² is H, optionally substituted alkyl or optionally substituted aryl,
R⁴ is any coloured organic group, which may or may not bear a reactive group able to form a dye-fibre bond,
Y is halogen.
   with an amine compound of formula (III)

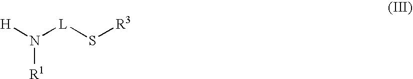

where
R¹ is H, optionally substituted alkyl or optionally substituted aryl,
R³ is optionally substituted alkyl or optionally substituted aryl, an organic acyl group (i.e. acetyl, propionyl, benzoyl etc.) or an organic thioacyl group (i.e. thioacetyl, thiopropionyl, thiobenzoyl etc.), all of which may or may not bear a reactive group able to form a dye-fibre bond
L is any carbon containing linking group that is aliphatic, aromatic, or a combined alkyl-aryl group such as benzyl or phenethyl,
   in water at a pH of about 8 to 12, preferably 9-10. In case where X is not halogen followed by a further reaction with a tertiary amine or an optionally substituted aryl amine to give dyestuff according to general formula (I) where X is a tertiary ammonium or an optionally substituted aryl amine.

Alternatively azo dyestuffs according to the general formula (I) can be synthesized starting from an aniline derivative of the general formula (IV)

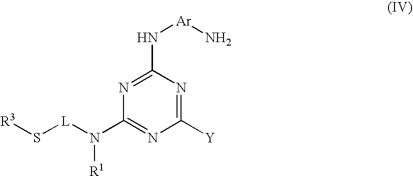

where Y, L and R³ are as defined above and Ar is an optionally substituted phenylene, reacting it with sodium nitrite followed by a conventional coupling onto a compound of the general formula (V)

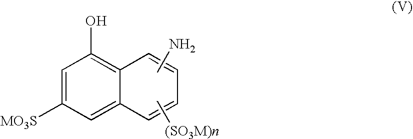

where

M is H, an alkali metal, an ammonium ion or the equivalent of an alkaline earth metal and n is an integer of 0 and 1 optionally followed by a further reaction with a tertiary amine or an optionally substituted aryl amine to give dyestuff according to general formula (I) where X is a tertiary ammonium or an optionally substituted aryl amine.

The dyestuffs of the instant invention are suitable for dyeing and printing hydroxy- and/or carboxamido-containing fibre materials by the application and fixing methods numerously described in the art for fibre-reactive dyes. They provide exceptionally bright, exceptionally strong and economic shades. Such dyes especially when used for exhaust dyeing of cellulosic materials can exhibit excellent properties including build-up, aqueous solubility, light-fastness, chlorine fastness, wash off and robustness to process variables. They are also wholly compatible with similar dyes designed for high temperature (80-100° C.) or moderate temperature (40-70° C.) application to cellulosic textiles, and thus lead to highly reproducible application processes, with short application times.

The present invention therefore also provides for use of the inventive dyestuffs for dyeing and printing hydroxy- and/or carboxamido-containing fibre materials and processes for dyeing and printing such materials using a dyestuff and a dyestuff mixture, respectively, according to the invention and also for the use in digital printing techniques, especially for ink jet printing. Usually the dyestuff is applied to the substrate in dissolved form and fixed on the fibre by the action of an alkali or by heating or both.

Hydroxy-containing materials are natural or synthetic hydroxy-containing materials, for example cellulose fiber materials, including in the form of paper, or their regenerated products and polyvinyl alcohols. Cellulose fibre materials are preferably cotton but also other natural vegetable fibres, such as linen, hemp, jute and ramie fibres. Regenerated cellulose fibres are for example staple viscose and filament viscose.

Carboxamido-containing materials are for example synthetic and natural polyamides and polyurethanes, in particular in the form of fibres, for example wool and other animal hairs, silk, leather, nylon-6,6, nylon-6, nylon-11, and nylon-4.

Application of the inventive dyestuffs is by generally known processes for dyeing and printing fibre materials by the known application techniques for fibre-reactive dyes. The dyestuffs according to the present invention are highly compatible with similar dyes designed for high temperature (80-10000) applications and are advantageously useful in exhaust dyeing processes.

Similarly, the conventional printing processes for cellulose fibres, which can either be carried out in single-phase, for example by printing with a print paste containing sodium bicarbonate or some other acid-binding agent and the colorant, and subsequent steaming at appropriate temperatures, or in two phases, for example by printing with a neutral or weakly acid print paste containing the colorant and subsequent fixation either by passing the printed material through a hot electrolyte-containing alkaline bath or by overpadding with an alkaline electrolyte-containing padding liquor and subsequent batching of this treated material or subsequent steaming or subsequent treatment with dry heat, produce strong prints with well defined contours and a clear white ground. Changing fixing conditions has only little effect on the outcome of the prints Not only in dyeing but also in printing the degrees of fixation obtained with dyestuffs or dyestuff mixtures of the invention are very high. The hot air used in dry heat fixing by the customary thermofix processes has a temperature of from 120 to 200°. In addition to the customary steam at from 101 to 103° C., it is also possible to use superheated steam and high pressure steam at up to 160° C.

Acid-binding agents responsible for fixing the dyes to cellulose fibers are for example water-soluble basic salts of alkali metals and of alkaline earth metals of inorganic or organic acids, and compounds which release alkali when hot. Of particular suitability are the alkali metal hydroxides and alkali metal salts of weak to medium inorganic or organic acids, the preferred alkali metal compounds being the sodium and potassium compounds. These acid-binding agents are for example sodium hydroxide, potassium hydroxide, sodium carbonate, sodium bicarbonate, potassium carbonate, sodium formate, sodium dihydrogen-phosphate and disodium hydrogen phosphate.

Treating the dyestuffs according to the invention with the acid-binding agents with or without heating bonds the dyestuffs chemically to the cellulose fibers. Especially the dyeings on cellulose, after they have been given the usual aftertreatment of rinsing to remove unfixed dye portions, show excellent properties.

The dyeings of polyurethane and polyamide fibres are customarily carried out from an acid medium. The dyebath may contain for example acetic acid and/or ammonium sulfate and/or acetic acid and ammonium acetate or sodium acetate to bring it to the desired pH. To obtain a dyeing of acceptable levelness it is advisable to add customary leveling auxiliaries, for example based on a reaction product of cyanuric chloride with three times the molar amount of an aminobenzenesulfonic acid or aminonaphthalenesulfonic acid or based on a reaction product of for example stearylamine with ethylene oxide. In general the material to be dyed is introduced into the bath at a temperature of about 40° C. and agitated therein for some time, the dyebath is then adjusted to the desired weakly acid, preferably weakly acetic acid, pH, and the actual dyeing is carried out at temperature between 60 and 98° C. However, the dyeings can also be carried out at the boil or at temperatures up to 120° C. (under superatmospheric pressure).

If used in the inkjet process the inventive dyestuffs are formulated in aqueous inks, which then are sprayed in small droplets directly onto the substrate. There is a continuous process, in which the ink is pressed piezoelectrically through a nozzle at a uniform rate and deflected onto the substrate by an electric field, depending on the pattern to be produced, and there is an interrupted inkjet or drop-on-demand process, in which the ink is expelled only where a colored dot is to be placed. The latter form of the process employs either a piezoelectric crystal or a heated cannula (bubble or thermojet process) to exert pressure on the ink system and so eject an ink droplet. These techniques are described in Text. Chem. Color, volume 19 (8), pages 23 ff. and volume 21, pages 27 ff.

The printing inks for the inkjet process contain one or more inventive dyes of the formula (I) in amounts, for example, of from 0.1% by weight to 50% by weight preferably in amounts of from 1% by weight to 30% by weight, and with particular preference in amounts of from 5% by weight to 25% by weight, based on the total weight of the ink. The pH of these printing inks is preferably adjusted to 7.0 to 9.0 by use of a suitable buffer system. This system is used in amounts of 0.1-3% by weight, preferably in 0.5-1.5% by weight, based on the total weight of the ink.

Useful buffer systems for printing inks include for example borax, disodium hydrogenphosphate, modified phosphonates, and buffer systems as described in: “Chemie der Elemente”, VCH Verlagsgesellschaft mbH, 1^{st} edition 1988, pages 665 to 666, Holleman-Wiberg, Lehrbuch der anorganisghen Chemie, WDG & Co. Verlage 47th to 56th edition, pages 109 to 110, Laborchemikalienverlag der Fa. MERCK, Darmstadt, Ausgabe 1999, pages 1128 to 1133, “Der Fischer Chemicals Katalog” (Fischer Scientific UK, 1999) pages 409 to 411, Riedel-de Haën, Laborchemikalien 1996, pages 946 to 951, Riedel-de Haën, Labor-Hilfstabellen No. 6, buffer solutions.

The dyestuffs of the formula (I) used in the inks of the inkjet process have in particular a salt content of less than 0.10% by weight, for example 0.01 to 0.099% by weight, based on the weight of the dyes. If necessary, the dyes have to be desalted, for example by membrane separation processes, before use in the inks according to the invention. For use of inks in the continuous flow process, a conductivity of 0.5 to 25 mS/m can be set by adding an electrolyte. Useful electrolytes include for example lithium nitrate and potassium nitrate.

The inks for the inkjet process may include further organic solvents with a total content of 1-20%, preferably 1-15% by weight, based on the total ink weight.

Suitable organic solvents include for example alcohols, e.g. methanol, ethanol, 1-propanol, isopropanol, 1-butanol, tert-butanol and pentyl alcohol; polyhydric alcohols, e.g. 1,2-ethanediol, 1,2,3-propanetriol, butanediol, 1,3-butanediol, 1,4-butanediol, 1,2-propanediol, 2,3-propanediol, pentanediol, 1,4-pentanediol, 1,5-pentanediol, 1,2-hexanediol, D,L-1,2-hexanediol, 1,6-hexanediol, and 1,2-octanediol;

polyalkylene glycols, e.g. polyethylene glycol, polypropylene glycol; alkylene glycols having 2 to 8 alkylene groups, e.g. monoethylene glycol, diethylene glycol, triethylene glycol, tetraethylene glycol, thioglycol, thiodiglycol, butyltriglycol, hexylene glycol, propylene glycol, dipropylene glycol, tripropylene glycol;
low alkyl ethers of polyhydric alcohols, e.g. ethylene glycol monomethyl ether, ethylene glycol monoethyl ether, ethylene glycol monobutyl ether,
diethylene glycol monomethyl ether, diethylene glycol monoethyl ether, diethylene glycol monobutyl ether, diethylene glycol monohexyl ether, triethylene glycol monomethyl ether, triethylene glycol monobutyl ether, tripropylene glycol monomethyl ether, tetraethylene glycol monomethyl ether, tetraethylene glycol monobutyl ether, tetraethylene glycol dimethyl ether, propylene glycol monomethyl ether, propylene glycol monoethyl ether, propylene glycol monobutyl ether and tripropylene glycol isopropyl ether;
polyalkylene glycol ethers, e.g. polyethylene glycol monomethyl ether, polypropylene glycol glycerol ether, polyethylene glycol tridecyl ether and polyethylene glycol nonylphenyl ether;
amines, e.g. methylamine, ethylamine, triethylamine, diethylamine, dimethylamine, trimethylamine, dibutylamine, diethanolamine, triethanolamine,
N-acetylethanolamine, N-formylethanolamine, ethylenediamine;
urea derivatives, e.g. urea, thiourea, N-methylurea, N,N′-dimethylurea, ethyleneurea, 1,1,3,3-tetramethylurea;
amides, e.g.: dimethylformamide, dimethylacetamide and acetamide;
ketones or ketoalcohols, e.g. acetone and diacetone alcohol,
cyclic ethers, e.g. tetrahydrofuran, trimethylolethane, trimethylolpropane, 2-butoxyethanol, benzyl alcohol, 2-butoxyethanol,
gamma-butyrolactone and ε-caprolactam;
also sulfolane, dimethylsulfolane, methylsulfolane, 2,4-dimethylsulfolane, dimethyl sulfone, butadiene sulfone, dimethyl sulfoxide, dibutyl sulfoxide, N-cyclohexylpyrrolidone, N-methyl-2-pyrrolidone, N-ethylpyrrolidone, 2-pyrrolidone, 1-(2-hydroxyethyl)-2-pyrrolidone, 1-(3-hydroxypropyl)-2-pyrrolidone, 1,3-dimethyl-2-imidazolidinone, 1,3-dimethyl-2-imidazolinone, 1,3-bismethoxymethylimidazolidine, 2-(2-methoxyethoxy)ethanol, 2-(2-ethoxyethoxy)ethanol, 2-(2-butoxyethoxy)ethanol, 2-(2-propoxyethoxy)ethanol, pyridine, piperidine, butyrolactone, trimethylolpropane, 1,2-dimethoxypropane, dioxane, ethyl acetate, ethylenediaminetetraacetate, ethyl pentyl ether, 1,2-dimethoxypropane and trimethylolpropane.

The printing inks for the inkjet process may further include the customary additives, for example viscosity moderators to set viscosities in the range from 1.5 to 40.0 mPa*s in a temperature range from 20 to 50° C. Preferred inks have a viscosity of 1.5 to 20 mPa*s and particularly preferred inks have a viscosity of 1.5 to 15 mPa*s.

Useful viscosity moderators include rheological additives, for example: polyvinylcaprolactam, polyvinylpyrrolidone and their copolymers, polyetherpolyol, associative thickeners, polyurea, polyurethane, sodium alginates, modified galactomannans, polyetherurea, polyurethane and nonionic cellulose ethers.

As further additives these inks may include surface-active substances to set surface tensions of 20 to 65 mN/m, which are adapted if necessary as a function of the process used (thermal or piezotechnology). Useful surface-active substances include for example:nonionic surfactants, butyldiglycol, 1,2-hexanediol.

The inks may further include customary additives, for example substances to inhibit fungal and bacterial growth in amounts of 0.01 to 1% by weight based on the total weight of the ink.

The inks may be prepared in a conventional manner by mixing their components in water in the desired proportions.

The examples herein below serve to illustrate the invention. Parts and percentages are by weight, unless otherwise stated. Parts by weight relate to parts by volume as the kilogram relates to the litre.

The compounds described in the examples in terms of a formula are indicated in the form of the free acids; in general, they are prepared and isolated in the form of their alkali metal salts, such as lithium, sodium or potassium salts, and used for dyeing in the form of their salts. The starting compounds and components mentioned in the following Examples in the form of the free acid can similarly be used in the synthesis as such or in the form of their salts, preferably alkali metal salts.

The visible region absorption maximum (λmax) reported for the dyes of the invention were determined in aqueous solution with reference to their alkali metal salts.

### EXAMPLE 1

### Compound (II-1) (7 mmol) and amine (III-1) (8 mmol)

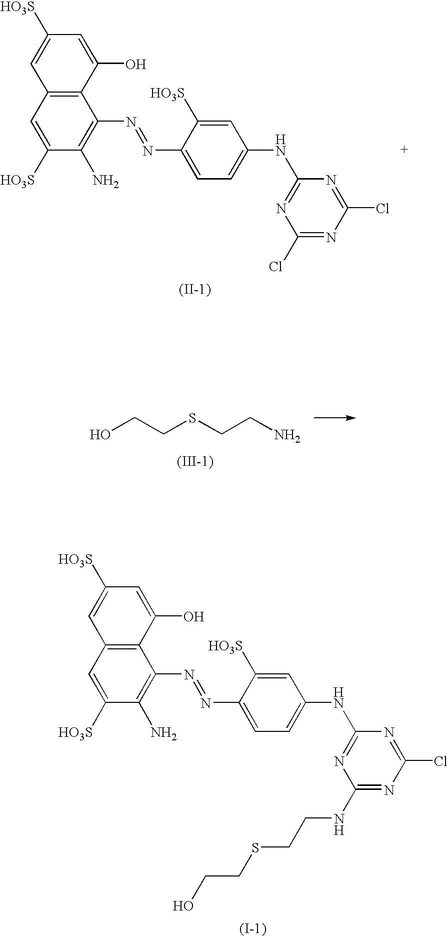

were stirred together in water at pH 10.0 for 4 hrs.

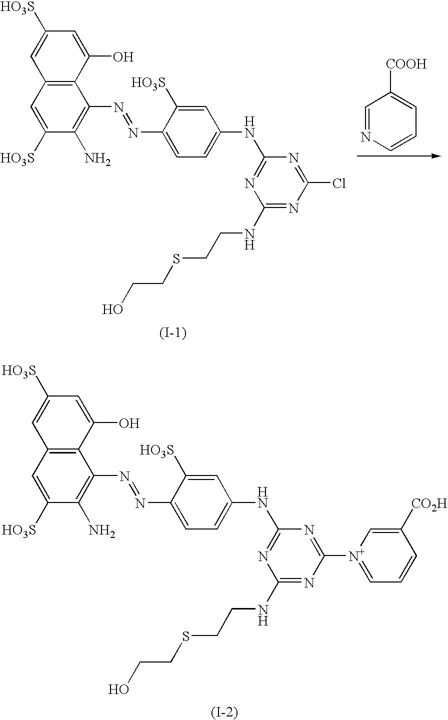

Nicotinic acid (35 mmol) was added to (1-1) and the mixture was heated at reflux for 8 hours. Methylated spirit was added and the resultant solid filtered off and dried to give a red powder (4.80 g, 80%-str, 66%). Analytical data were consistent with the required product (I-2); UV: □max=532.5 nm, εmax=32000.

### EXAMPLE 2

The structures (I-3) to (I-6), were prepared in an analogous fashion to example 1. In each case analytical data were in full agreement with the respective structures.

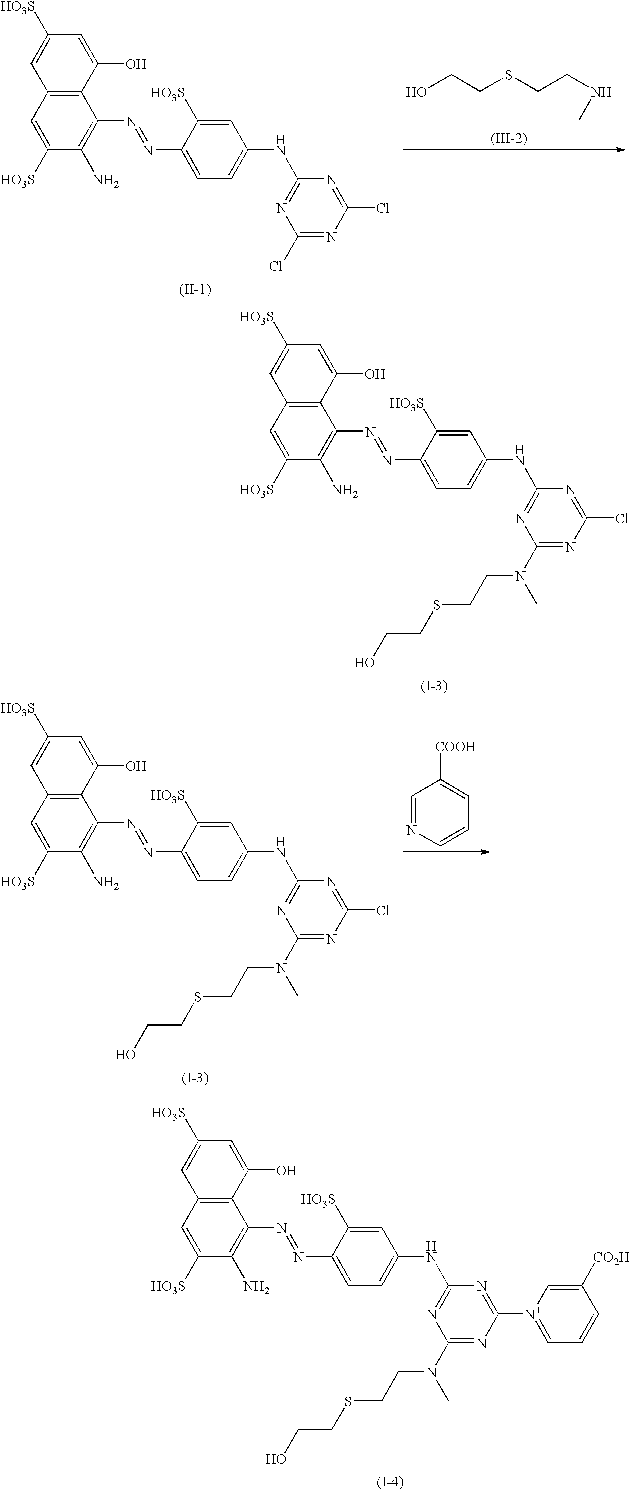

UV: □max=532.5 nm, εmax=32000.

### EXAMPLE 3

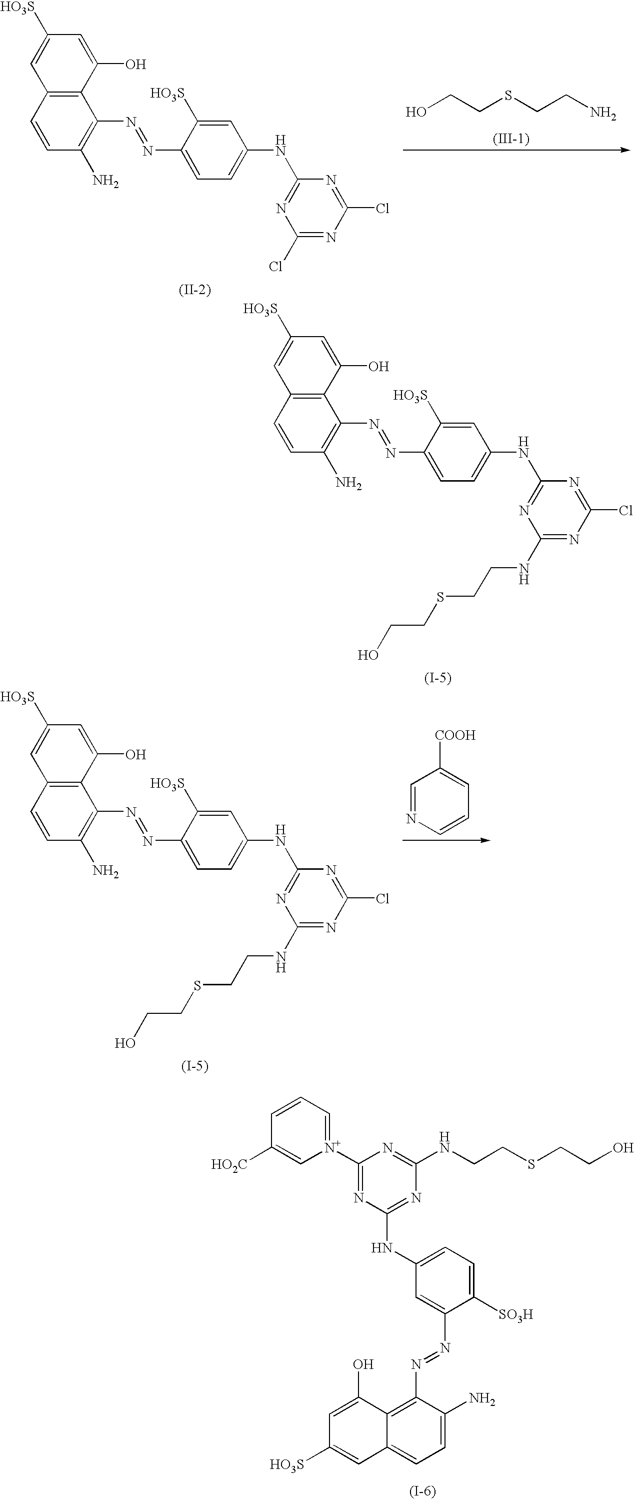

UV: □max=517.5 nm, εmax=16000

### EXAMPLE 4

Compound (II-3) (4.3 mmol) and amine (III-1) (9.9 mmol) were stirred together in water at pH 9.0 for 2 hrs. Salt was added, the solid isolated by filtration and dried to give a dark blue powder (5.75 g, 70%-str, 79%).

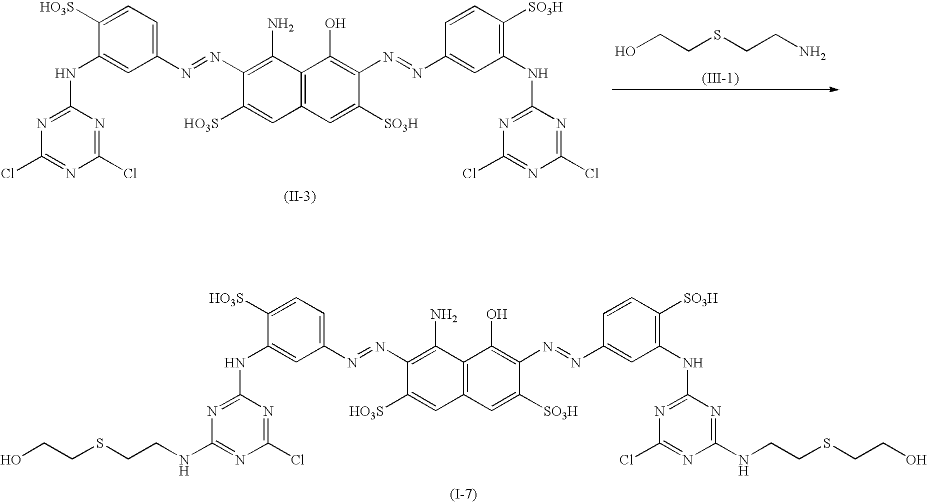

Analytical data were consistent with the required product (I-7); UV: □max 609.0 nm, εmax=48000.

### EXAMPLE 5

To compound (IV-1) (20 mmol) in water (250 ml) was added ice (100 g) and HCl (15 ml, 31%). Sodium nitrite (21 mmol) was added and the reaction mixture was stirred for 5 minutes. Compound (V) (13 mmol) was added and stirred at pH 6.0 for 1 hour. Salt was added and the resultant solid isolated by filtration, dialyzed to remove excess salt and dried to a dark blue powder (10.5 g, 73%-str, 60%)

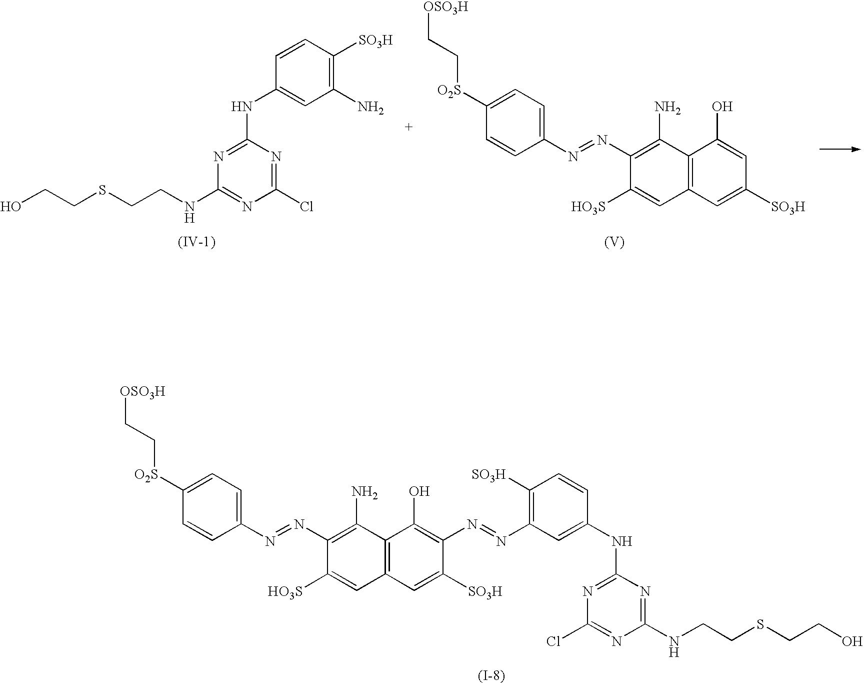

Analytical data were consistent with the required product (1-8);

UV: □max=609.0 nm, εmax=56000.

### EXAMPLE 6

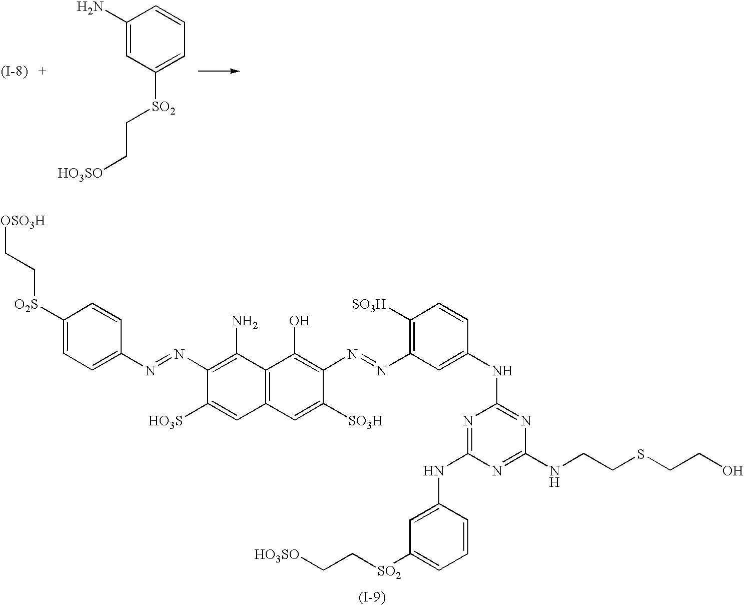

Dyestuff (I-8) (2.1 mmol) was reacted with 2.5 mmol 3-β-sulfatoethylsulfonyl-phenylamine at 50° C., pH 2.5 for 16 hrs in water. Upon addition of methylated spirit, the resultant solid isolated by filtration and dried to give a dark blue powder (2.1 g, 82%-str, 64%). Analytical data were consistent with the required product (I-9); UV: □max=609.0 nm, εmax=56000.

### EXAMPLE 7

Dyestuff (I-7) (2.1 mmol) was reacted with 5 mmol 3-β-sulfatoethylsulfonyl-phenylamine at 50° C., pH 2.5 for 16 hrs in water. Upon addition of methylated spirit, the resultant solid isolated by filtration and dried to give a dark blue powder (2.1 g, 82%-str, 64%). Analytical data were consistent with the required product (1-10);

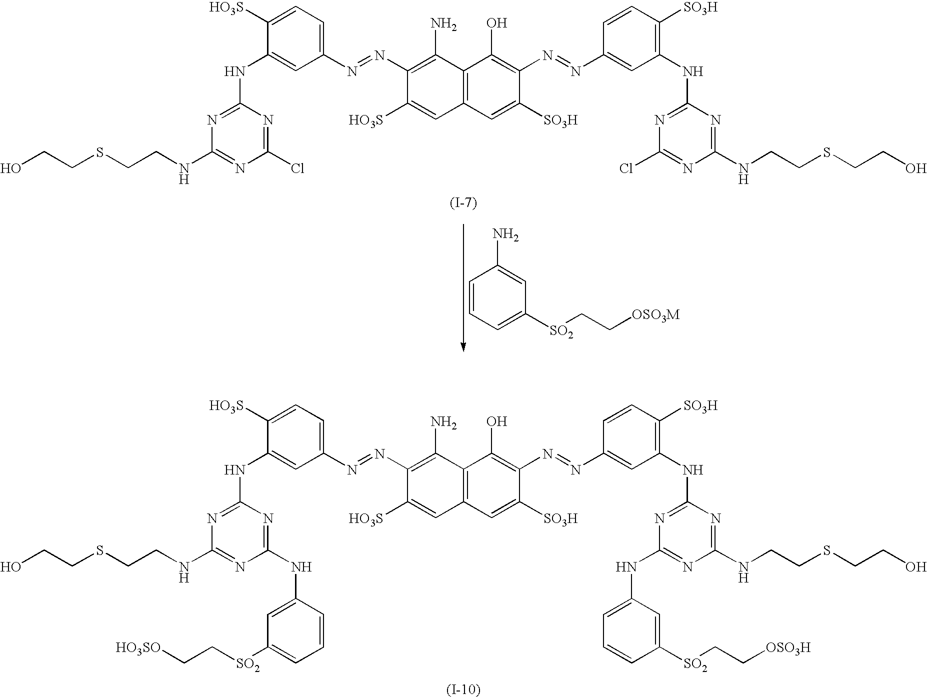

UV: □max=613.0 nm, εmax=55000.

The following dyestuffs were prepared according to an analogous procedure:

| Dye- | | |
|---|---|---|
| stuff | | □max |
| No: | Structure | in H₂O |
| (I-11) | 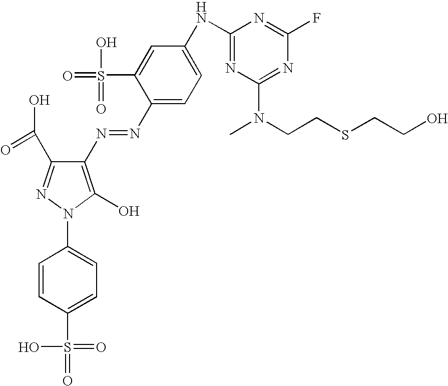 | 445 nm |
| (I-12) | 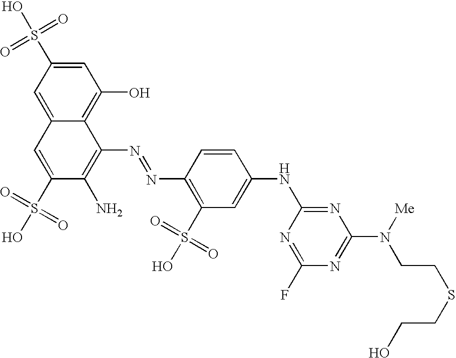 | 525 nm |
| (I-13) | 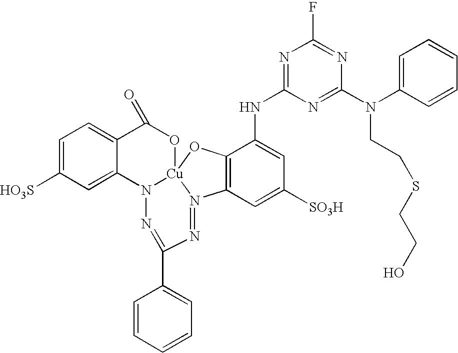 | 611 nm |
| (I-14) | 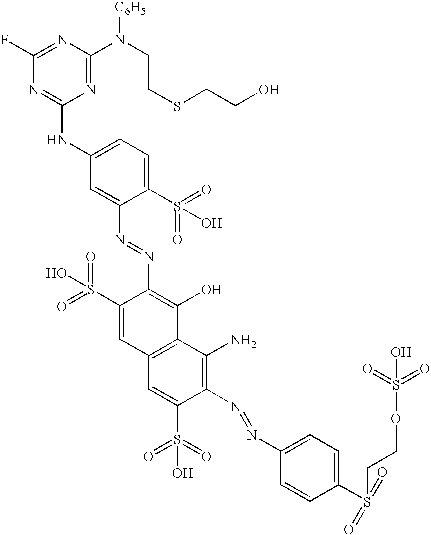 | 592 nm |
| (I-15) | 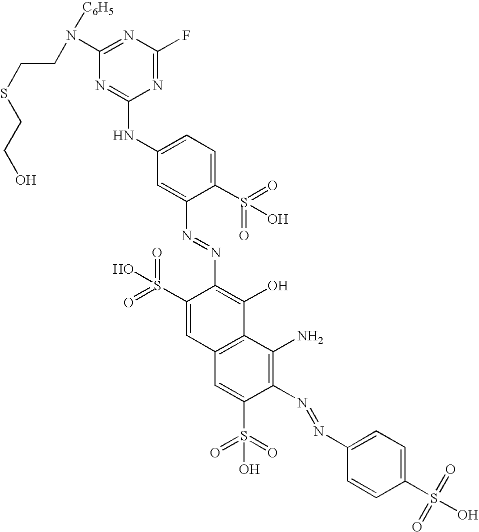 | 597 nm |
| (I-16) | 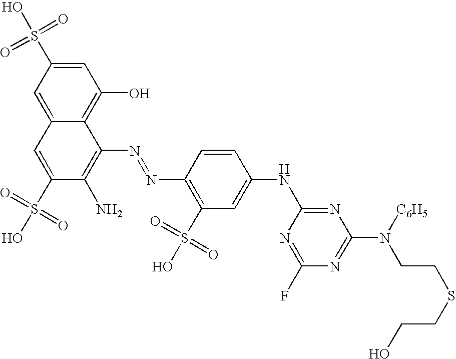 | 523 nm |
| (I-17) | 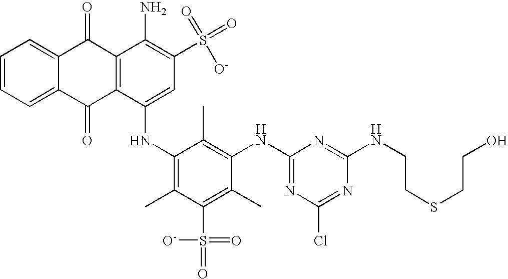 | 587 nm |
| (I-18) | 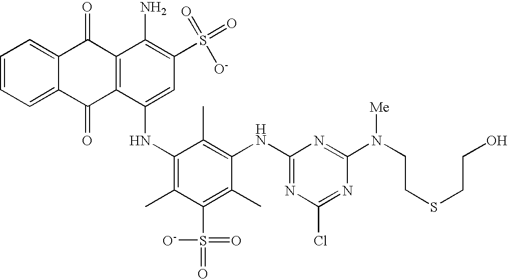 | 626 nm |
| (I-19) | 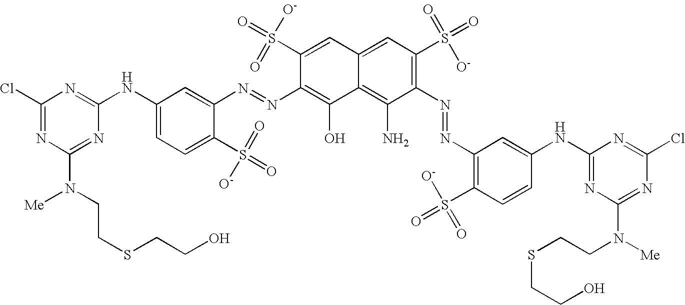 | 606 nm |
| (I-20) | 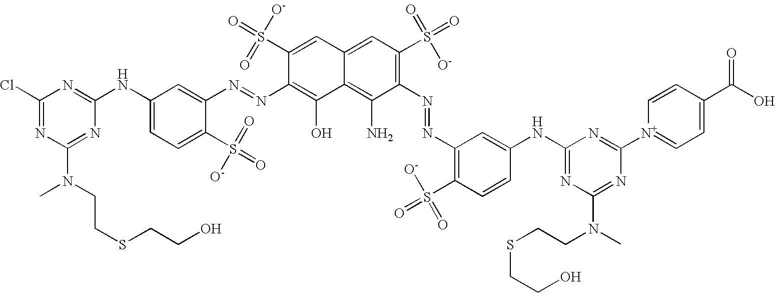 | 591 nm |
| | Mixture with regioisomer with pyridinium moiety on the right | |
| (I-21) | 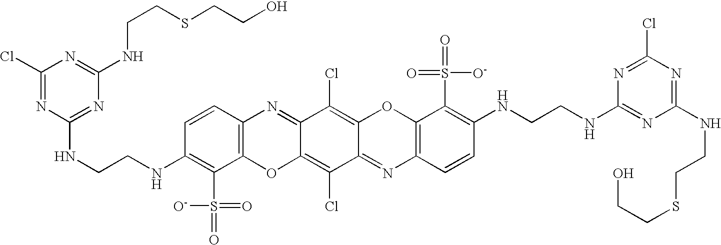 | 638 nm |
| (I-22) | 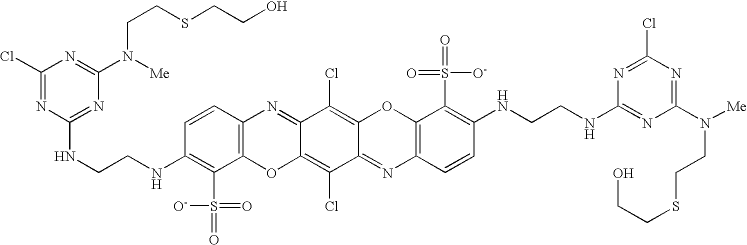 | 638 nm |
| (I-23) | 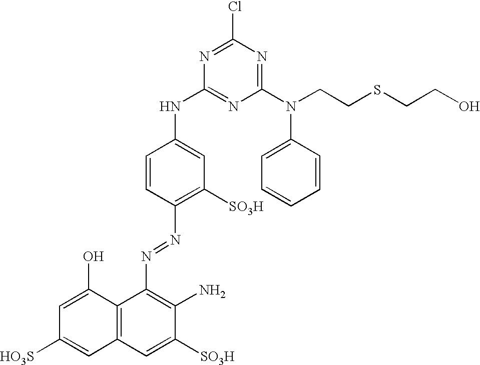 | 527 nm |
| (I-24) | 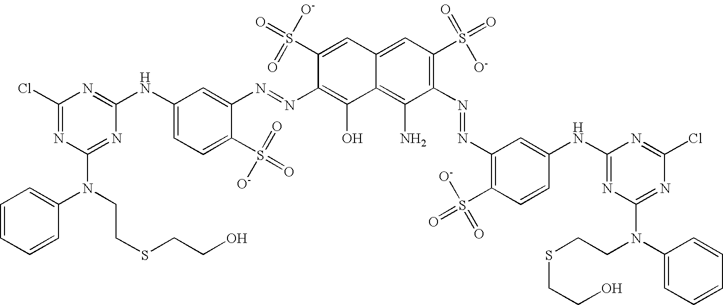 | 607 nm |
| (I-25) | 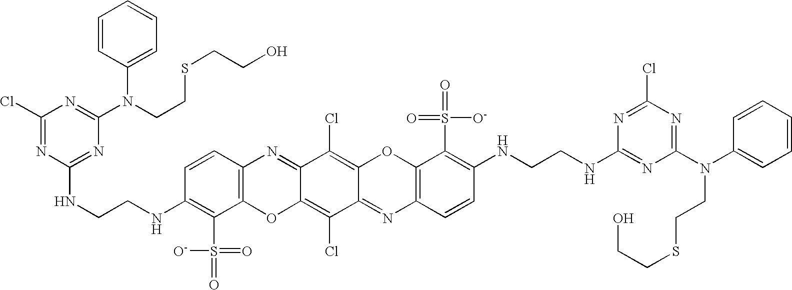 | 632 nm |
| (I-26) | 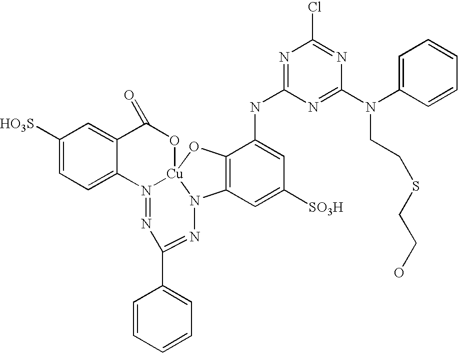 | 618 nm |

### EXAMPLE 8

A textile fabric of mercerized cotton is padded with liquor containing 35 g/l of anhydrous sodium carbonate, 100 g/l of urea and 150 g/l of a low viscosity sodium alginate solution (6%) and then dried. The wet pickup is 70%.

The thus pretreated textile is printed with an aqueous ink including

### 2% of dye (I-2)

20% of sulfolane,

### 0.01% of Mergal K9N,

77.99% of water
using a drop-on-demand (bubble jet) inkjet print head. The print is fully dried. It is fixed by means of saturated steam at 102° C. for 8 minutes. The print is then rinsed warm, subjected to a fastness wash with hot water at 95° C., rinsed warm and then dried.

The result is a bluish red or magenta print having excellent use fastnesses.

1-9. (canceled)

10. A dyestuff of the general formula (I) 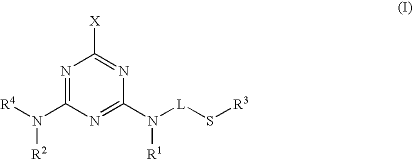
wherein
R¹ and R² are independently H, optionally substituted alkyl or optionally substituted aryl,
R³ is optionally substituted alkyl or optionally substituted aryl, an organic acyl group or an organic thioacyl group, all of which may or may not bear a reactive group able to form a dye-fibre bond,
R⁴ is any colored organic group, which may or may not bear a reactive group able to form a dye-fibre bond,
L is any carbon containing linking group that is aliphatic, aromatic, or a combined alkyl-aryl group,
X is halogen or tertiary ammonium or an optionally substituted aryl amine.

11. The dyestuff according to claim 10, wherein
R³ is optionally acetyl, propionyl, benzoyl, thioacetyl, thiopropionyl, or thiobenzoyl group, all of which may or may not bear a reactive group able to form a dye-fibre bond, and
L is benzyl or phenethyl.

12. The dyestuff according to claim 10, wherein
R¹ and R² are hydrogen or methyl,
R³ is C₁-C₄ alkyl, hydroxyethyl or hydroxypropyl, sulfatoethyl, phosphatoethyl, sulfatopropyl or phosphatopropyl,
R⁴ is an azo based chromophoric system, and
X is chlorine, fluorine or tertiary ammonium salt.

13. A process for preparing the dyestuff of formula (I) as claimed in 10 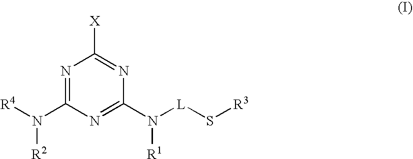
which comprises reacting a dyestuff of the formula (II) 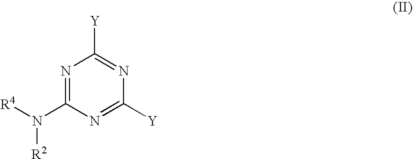
wherein
R¹ is H, optionally substituted alkyl or optionally substituted aryl,
R⁴ is any colored organic group, which may or may not bear a reactive group able to form a dye-fibre bond,
Y is halogen,
with an amino compound of formula (III) 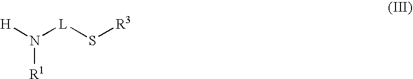
where
R¹ is H, optionally substituted alkyl or optionally substituted aryl,
R³ is optionally substituted alkyl or optionally substituted aryl, an organic acyl group or an organic thioacyl group, all of which may or may not bear a reactive group able to form a dye-fibre bond
L is any carbon containing linking group that is aliphatic, aromatic, or a combined alkyl-aryl group,
in water at a pH of about 8 to 12 followed by a further reaction with a tertiary amine or an optionally substituted aryl amine to give dyestuff according to general formula (I) where X is a tertiary ammonium or an optionally substituted aryl amine.

14. The process according to claim 13, wherein
R³ is optionally acetyl, propionyl, benzoyl, thioacetyl, thiopropionyl, or thiobenzoyl group, all of which may or may not bear a reactive group able to form a dye-fibre bond, and
L is benzyl or phenethyl.

15. A process for preparing azo dyestuffs according to the general formula (I) as claimed in claim 10 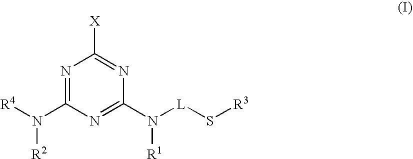
which comprises reacting an aniline derivative of the general formula (IV) 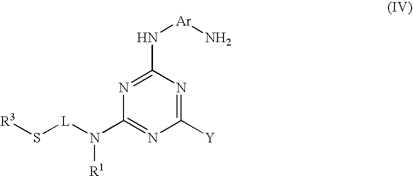
wherein
R¹ is H, optionally substituted alkyl or optionally substituted aryl,
R³ is optionally substituted alkyl or optionally substituted aryl, an organic acyl group or an organic thioacyl group, all of which may or may not bear a reactive group able to form a dye-fibre bond,
L is any carbon containing linking group that is aliphatic, aromatic, or a combined alkyl-aryl group,
Y is halogen, and
Ar is an optionally substituted phenylene,
with sodium nitrite,
followed by a coupling onto a compound of the general formula (V) 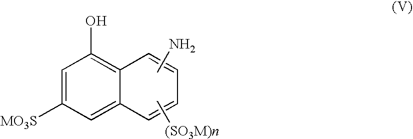
wherein
M is H, an alkali metal, an ammonium ion or the equivalent of an alkaline earth metal and
n is an integer of 0 and 1
optionally followed by further reacting with a tertiary amine or an optionally substituted aryl amine to give dyestuff according to general formula (I) where X is a tertiary ammonium or a substituted aryl amine.

16. A process for dyeing and printing hydroxy- and/or carboxamido-containing fibre material which comprises contacting the material with the dyestuff of the formula (I) according to claim 10.

17. A process for printing hydroxyl- and/or carboxamido-containing fiber material which comprises digital printing the dyestuff of the formula (I) according claim 10 to the material.

18. A process for printing hydroxyl- and/or carboxamido-containing fibre materials which comprises ink jet printing the dyestuff of the formula (U) according claim 10 to the material.

19. A printing ink for the inkjet process comprising one or more dyestuff of the formula (I) according to claim 10.

20. A hydroxy- and/or carboxamido containing fiber material which has fixed the dyestuff of the formula (I) according to claim 10.
